(19) United States
(12) Patent Application Publication
(10) Pub. No.: US 2026/0287230 A1
(43) Pub. Date: Sep. 24, 2026

(54) FREE-COOLING SYSTEM SUITABLE FOR CHILLERS

(71) Applicant: Tyco Fire & Security GmbH, Neuhausen am Rheinfall (CH)

(72) Inventors: William L. KOPKO, Jacobus, PA (US); Jing LI, Red Lion, PA (US)

(21) Appl. No.: 19/112,916

(22) PCT Filed: Oct. 6, 2023
(86) PCT No.: PCT/US2023/076180

§ 371 Date: Mar. 18, 2025

Related U.S. Application Data
(60) Provisional application No. 63/378,592, filed on Oct. 6, 2022.

(51) Int. Cl. F25B 49/02; F25B 39/02

(52) U.S. Cl. CPC F25B 49/02; F25B 39/02; F25B 2600/13; F25B 2600/25

(57) ABSTRACT

A heating, ventilation, air conditioning, and refrigeration system includes: two or more cooling coils configured to receive a flow of a refrigerant; a mechanical cooling loop in fluid communication with the two or more cooling coils; a free-cooling loop in fluid communication with the cooling coils; a pump in fluid communication with the cooling coils; and a controller. The controller is configured to operate a speed of the pump to apportion the flow of the refrigerant between the two or more cooling coils such that a first portion of the refrigerant flowing through at least one of the two or more cooling coils is flowing along the mechanical cooling loop and a second portion of the refrigerant flowing through at least one of the two or more cooling coils is flowing along the free-cooling loop. The mechanical cooling loop and the free-cooling loop are configured to operate simultaneously.

### CROSS-REFERENCE TO RELATED APPLICATION

This application claims the benefit of U.S. Provisional Patent Application No. 63/378,592, filed Oct. 6, 2022 and hereby incorporates by reference herein the contents of this application.

### BACKGROUND

Aspects of the present disclosure relate generally to systems and methods for use in refrigeration systems. Specifically, the present disclosure relates to systems and methods for use in refrigeration systems that include a free-cooling system and a mechanical cooling system.

Refrigeration and air conditioning systems may rely on chillers to reduce the temperature of a working fluid, typically water. In such applications, the chilled water may be passed through downstream equipment, such as air handlers, to cool other fluids, such as air in a building. In typical chillers, the working fluid is cooled by an evaporator that absorbs heat from the working fluid by evaporating refrigerant. The refrigerant is then compressed by a compressor and transferred to a condenser. In the condenser, the refrigerant is cooled, typically by air or water flows, and recondensed into a liquid. Air cooled condensers typically comprise one or more condenser coils and one or more fans that induce airflow over the coils. Some systems may include a free-cooling system and a mechanical cooling system.

The mechanical cooling system may be a vapor-compression refrigeration cycle, which may include a condenser, an evaporator, a compressor, and/or an expansion device. In the evaporator, liquid or primarily liquid refrigerant is evaporated by drawing thermal energy from an air flow stream and/or a chilled fluid (e.g., water), which may also flow through the liquid to-air heat exchanger of the free-cooling system. In the condenser, the refrigerant is de-superheated, condensed, and sub-cooled. In some cases, refrigeration systems may adjust a speed of a fan of the liquid-to-air heat exchanger and/or a speed of a compressor in the mechanical cooling system to meet a desired cooling demand.

In some aspects, the free-cooling system may include a liquid-to-air heat exchanger, which is used throughout industry and in many heating, ventilating, and residential, commercial, and industrial air conditioning applications. During free-cooling, cool outdoor air may be used to cool the refrigerant, and the compressor is not used, resulting in energy savings.

Conventional cooling systems that use both mechanical cooling and free-cooling may use separate cooling coils for the mechanical cooling system and the free-cooling system. This can add expense and complication to such systems. Additionally, some conventional cooling systems that use both mechanical cooling and free-cooling are limited to operating the free-cooling when the compressor is not running. Moreover, in conventional cooling systems, the available free-cooling capacity is limited.

### SUMMARY

In an aspect, a heating, ventilation, air conditioning, and refrigeration system includes two or more cooling coils configured to receive a flow of a refrigerant, a mechanical cooling loop in fluid communication with the two or more cooling coils, a free-cooling loop in fluid communication with the two or more cooling coils, a pump in fluid communication with the two or more cooling coils, and a controller. The controller is configured to operate a speed of the pump to apportion the flow of the refrigerant between the two or more cooling coils such that a first portion of the refrigerant flowing through at least one of the two or more cooling coils is flowing along the mechanical cooling loop and a second portion of the refrigerant flowing through at least one of the two or more cooling coils is flowing along the free-cooling loop. The mechanical cooling loop and the free-cooling loop are configured to operate simultaneously.

In another aspect, a heating, ventilation, air conditioning, and refrigeration system includes a condenser, a heat exchanger, a plurality of cooling towers, and a controller. Each of the plurality of cooling towers includes a valve allowing access to the cooling tower and a pump configured to pump refrigerant through the cooling tower. The controller is configured to receive information indicative of one or more of receive information indicative of an ambient temperature, a temperature of refrigerant leaving the plurality of cooling towers, a temperature of building water to be cooled by the heat exchangers, or combinations thereof from a temperature sensor. The controller is configured to open or close one or more of the valves to allow or prevent access to one or more of the plurality of cooling towers based on the received temperature information.

### BRIEF DESCRIPTION OF THE DRAWINGS

FIG. 1 is perspective view, with cut-away portions, of a commercial or industrial environment that employs a refrigeration system, in accordance with an aspect of the present disclosure.

FIG. 2 is a perspective view of the refrigeration system of FIG. 1 that may include both a free-cooling system and a mechanical cooling system to enhance efficiency of the refrigeration system, in accordance with an aspect of the present disclosure.

FIG. 3 is a block diagram of a refrigeration system in which a plurality of cooling coils is shared between a mechanical cooling loop and a free-cooling loop in accordance with an aspect of the present disclosure;

FIG. 4 is a block diagram of another refrigeration system in which a plurality of cooling coils is shared between a mechanical cooling loop and a free-cooling loop in accordance with an aspect of the present disclosure;

FIG. 5 is a block diagram of a refrigeration system that includes a mechanical cooling loop, a free-cooling loop, and a plurality of cooling towers in accordance with an aspect of the present disclosure;

FIG. 6 is a block diagram of another refrigeration system that includes a mechanical cooling loop, a free-cooling loop, and a plurality of cooling towers in accordance with an aspect of the present disclosure; and

FIG. 7 is a block diagram of a controller that can be used with the refrigeration systems of FIGS. 3-6 in accordance with an aspect of the present disclosure.

### DETAILED DESCRIPTION

The present disclosure is directed to a refrigeration system that includes a free-cooling system and a mechanical cooling system for cooling a load. As used herein, a free-cooling system may include a system that places a fluid in a heat exchange relationship with ambient air. Accordingly, the free-cooling system may utilize the ambient air in a surrounding environment as a cooling and/or a heating fluid. As used herein, a mechanical cooling system may include a system that utilizes a refrigeration cycle of a chiller to perform cooling. The refrigeration system may utilize the free-cooling system alone (e.g., free-cooling mode), the mechanical cooling system alone (e.g., mechanical cooling mode), or the free-cooling system and the mechanical cooling system simultaneously (e.g., hybrid cooling mode). To determine which system(s) to operate, the refrigerant system may include various sensors and/or other monitoring devices that measure operating conditions (e.g., speed of fans, speed of a compressor, ambient air temperature, cooling fluid temperature) of the refrigeration system. For example, in accordance with aspects of the present disclosure, the determination of which system(s) to operate may depend at least on a desired cooling load demand (e.g., a desired temperature of the load) and/or an ambient air temperature (e.g., a temperature of a surrounding environment of the refrigeration system).

The described aspects allow use of the same cooling elements, e.g., coils or dry cooling towers, for both free-cooling and for mechanical cooling, and also provide options for simultaneous operation shifting the coils or dry cooling towers between the mechanical cooling mode and the free-cooling mode.

In one example implementation, a refrigerant liquid pump circulates liquid refrigerant between a condenser coils and a refrigerant-water heat exchanger to provide free-cooling without compressor operation. The same condenser coils are used for condensing refrigerant exiting a compressor during the mechanical cooling mode without operation of the free-cooling pump. In the hybrid cooling mode, the compressor and refrigerant liquid pump run simultaneously with liquid, or liquid-rich two-phase, fed from a pump end of a coil header and vapor, or vapor-rich two-phase, fed from a compressor end at an opposite end of the header.

In another example implementation, a dry cooling tower system uses two glycol pumps that supply glycol from opposite heads of a header connected to multiple coils. One pump circulates glycol through a condenser associated with a chiller or other mechanical cooling system. The other pump circulates liquid through a free-cooling loop that includes a glycol-water heat exchanger. The relative flows of the two pumps creates a natural flow boundary to allow simultaneous free-cooling and mechanical cooling with substantially different glycol temperatures in the two loops.

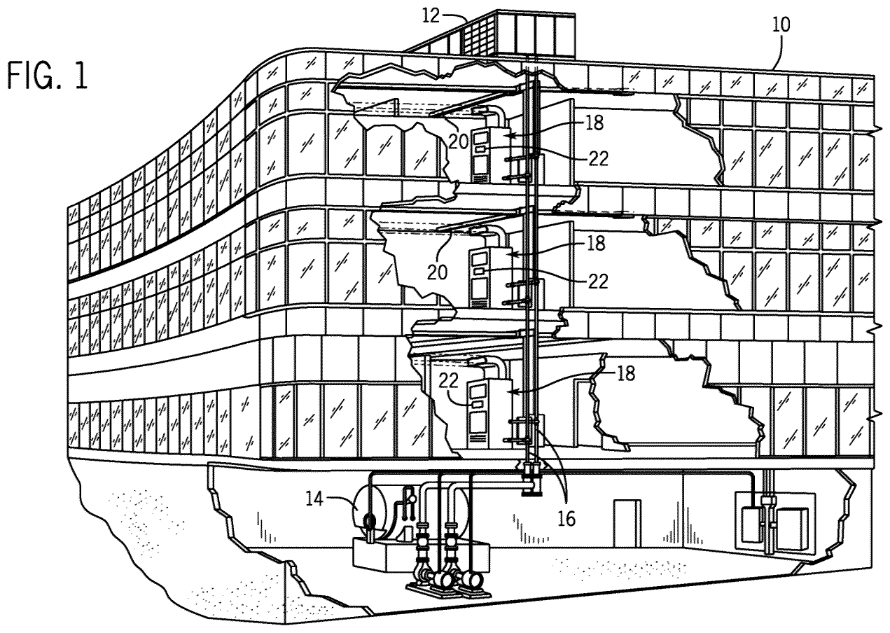

Turning now to the figures, FIG. 1 depicts an example application for a refrigeration system. Such systems, in general, may be applied in a range of settings, both within the heating, ventilating, air conditioning, and refrigeration (HVAC&R) field and outside of that field. The refrigeration systems may provide cooling to data centers, electrical devices, freezers, coolers, or other environments through vapor-compression refrigeration, absorption refrigeration, and/or thermoelectric cooling. In presently contemplated applications, however, refrigeration systems may also be used in residential, commercial, light industrial, industrial, and in any other application for heating or cooling a volume or enclosure, such as a residence, building, structure, and so forth. Moreover, the refrigeration systems may be used in industrial applications, where appropriate, for basic refrigeration and heating of various fluids.

FIG. 1 includes a heating, ventilating, air conditioning, and refrigeration system (HVAC&R) for building environmental management that may employ one or more heat exchangers. For example, a building 10 is cooled by a system that includes a refrigeration system 12 and a boiler 14. The refrigeration system 12 is disposed on the roof of the building 10 and the boiler 14 is located in the basement, however, the refrigeration system 12 and the boiler 14 may be located in other equipment rooms or areas next to the building 10. The refrigeration system 12 is an air cooled (e.g., free-cooling) device and/or a mechanical cooling system that implements a refrigeration cycle to cool water (or another cooling fluid, such as glycol). The refrigeration system 12 is housed within a single structure that may include a mechanical cooling circuit, a free-cooling system, and associated equipment such as pumps, valves, and piping. For example, the refrigeration system 12 may be a single package rooftop unit that incorporates a free-cooling system and a mechanical cooling system. The boiler 14 is a closed vessel that includes a furnace to heat water. The water (or another cooling fluid) from the refrigeration system 12 and the boiler 14 is circulated through the building 10 by water conduits 16. The water conduits 16 are routed to air handlers 18, located on individual floors and within sections of building 10.

The air handlers 18 are coupled to ductwork 20 that is adapted to distribute air between the air handlers 18 and may receive air from an outside intake. The air handlers 18 include heat exchangers that circulate cold water from the refrigeration system 12 and hot water from the boiler 14 to provide heated or cooled air. Fans, within the air handlers 18, draw air across coils of the heat exchangers and direct the conditioned air to environments within the building 10, such as rooms, apartments, or offices, to maintain the environments at a designated temperature. A control device 22, such as a thermostat, may be used to designate the temperature of the conditioned air. The control device 22 may also be used to control the flow of air through and from the air handlers 18. Other devices may be included in the system, such as control valves that regulate the flow of water and pressure and/or temperature transducers or switches that sense the temperatures and pressures of the water, the air, and so forth. Moreover, the control devices may include computer systems (e.g., a memory storing computer-readable instructions, and a processor configured to execute the computer-readable instructions to perform the actions recited herein) that are integrated with and/or separate from other building control or monitoring systems, including systems that are remote from the building 10. It should be noted that while water is discussed as a cooling fluid, any suitable cooling fluid may be utilized in the refrigeration system 12.

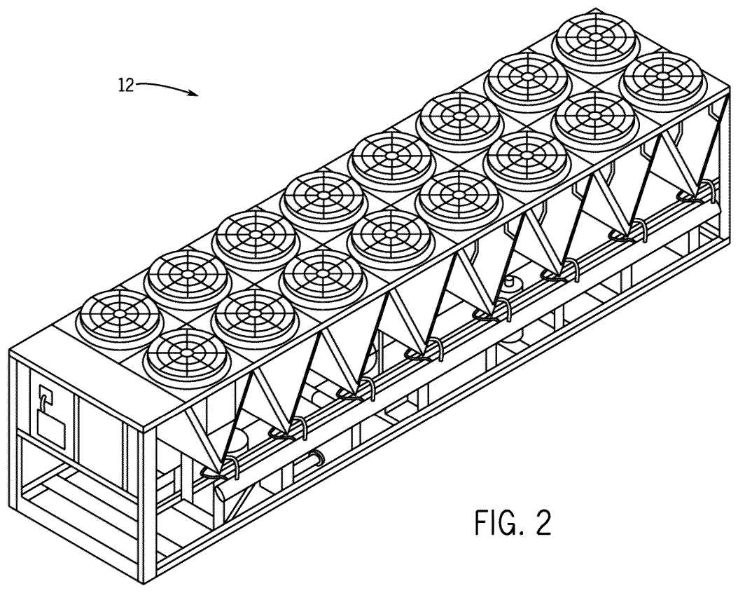

In accordance with aspects of the present disclosure, the refrigeration system 12 may include a mechanical cooling system and a free-cooling system that may be modified and/or enhanced to share cooling elements, such as coils or dry cooling towers, to improve an efficiency of operation of the refrigeration system 12. For example, FIG. 2 is a perspective view of the refrigeration system 12 that may include both a mechanical cooling system (e.g., a vapor-compression refrigeration cycle) and a free-cooling system to enhance an efficiency of the overall refrigeration system 12. In certain aspects, the mechanical cooling system of the refrigeration system 12 may be an air-cooled variable-speed screw chiller similar to that of a YVAA chiller, as made available by Johnson Controls Incorporated. For example, the mechanical cooling system may be a two-circuit, variable-speed screw chiller with variable speed condenser fans (e.g., fans that may be used with one or more air-cooled heat exchangers). Additionally, the refrigeration system 12 may include a free-cooling system that may be utilized alone, or in combination with, the mechanical cooling system (e.g., a vapor-compression refrigeration cycle).

In certain aspects, the refrigeration system 12 may include a control system (e.g., a memory storing computer-readable instructions, and a processor configured to execute the computer-readable instructions to perform the actions recited herein) configured to determine whether (and how) to operate the mechanical cooling system and/or the free-cooling system to apportion use of the shared cooling elements based on a temperature of ambient air (e.g., air in a surrounding environment of the refrigeration system) and/or a cooling load demand (e.g., an amount of cooling demanded by a load). Accordingly, the refrigeration system 12 may operate the mechanical cooling system only (e.g., mechanical cooling mode), the free-cooling system only (e.g., free-cooling mode), or the mechanical cooling system and the free-cooling system simultaneously (e.g., hybrid cooling mode) to meet the cooling load demand.

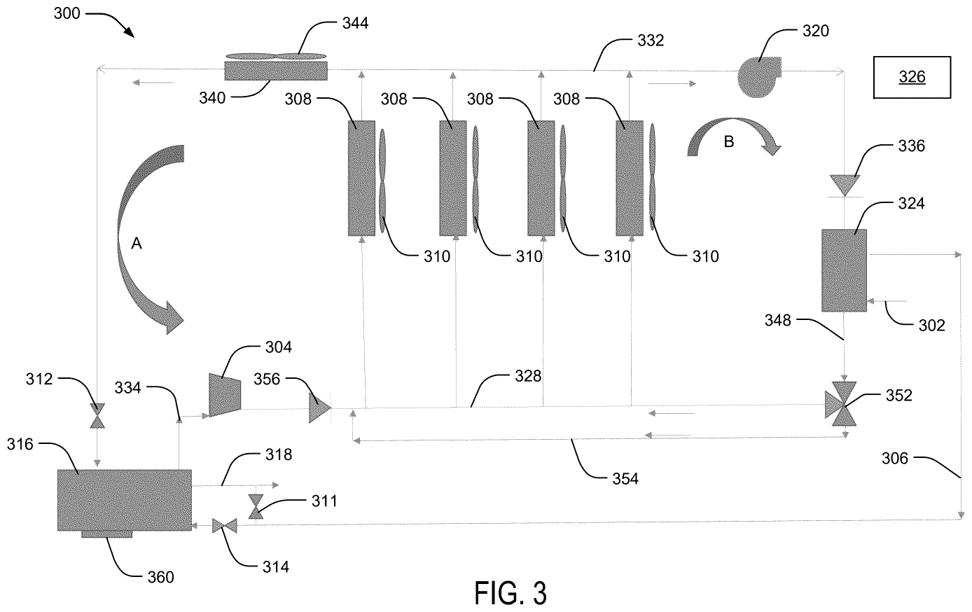

Referring to FIG. 3, for example, a refrigeration system 300 configured to be utilized in accordance with aspects of the present disclosure and includes a mechanical cooling loop, depicted by arrow A, and a free-cooling loop, depicted by arrow B, operable to share the use of cooling coils 308, separately or simultaneously, under control of controller 326 (e.g., a processor) to perform efficient cooling. Refrigeration system 300 may be the same as or similar to what is discussed above with regard to the refrigeration system 12. In the mechanical cooling loop, refrigerant in an evaporator 316 expands cool liquid from the building 10 (FIG. 1) received via pipe 306, and the resulting vapor refrigerant feeds into a compressor 304. In some aspects, the liquid from the building 10 may be not be limited to water. The compressor 304 operates to compress the vapor refrigerant into high temperature and high pressure superheated vapor that is fed into cooling coils 308 coupled to fans 310 for condensing the high temperature and high pressure superheated vapor into liquid. Further, the mechanical cooling loop may include an expansion valve 312 to control a portion of the flow of the subcooled liquid refrigerant in subcooler 340 back to the evaporator 316 and compressor 304. In the free-cooling loop, depicted by arrow B, a pump 320 controllably directs another portion of the flow of the cooled liquid or two-phase flow to a heat exchanger 324, such as based on commands from a controller 326. Further, in the free-cooling loop, cooled liquid refrigerant or a mixture of liquid and vapor refrigerant cools the water from the building 10 (FIG. 1) received via pipe 302, and directs the cooled water back to the building 10 (FIG. 1) via pipes 306 and 318. Further, in the free-cooling loop, cooled liquid refrigerant or a mixture of liquid and vapor refrigerant flows from the heat exchanger 324 back to the cooling coils 308, as described in more detail below. Thus, the refrigeration system 300 controllably shares use of the cooling coils 308 to perform mechanical cooling, free-cooling, or both simultaneously.

In some aspects, the cooling coils 308 may be microchannel coils with single refrigerant pass. In such aspects, the cooling coils 308 may be aluminum. In such aspects, the cooling coils 308 are less likely to corrode because the refrigerant (e.g., instead of water and/or glycol) flows through the cooling coils 308. In other aspects, the cooling coils 308 may be aluminum or copper plate-fin coils with copper tubes. The cooling coils 308 may be configured to accommodate both condensing vapor and liquid refrigerant without a large pressure drop. In some aspects, the heat exchanger 324 may be a brazed-plate heat exchanger. In some aspects, the pump 320 is a variable speed pump.

The refrigeration system 300 can be operated in first or a mechanical cooling mode, a second or a free-cooling mode, and a third or hybrid mode that is a combination of the mechanical cooling mode and the free-cooling mode. All of the cooling coils 308 may be used as condenser coils of the mechanical cooling loop when the system 300 is operating in the mechanical cooling mode. Also, advantageously relative to prior systems with restricted capacity, all of the cooling coils 308 may be used in the free-cooling loop when the system 300 is operating in the free-cooling mode. When the system 300 is operating in the hybrid mode, a first portion of the cooling coils 308 may operate in the mechanical cooling loop and, simultaneously, a second portion of the cooling coils 308 may operate in the free-cooling loop, wherein the respective portions may be controlled by the controller 326 as described herein, such that all of the cooling coils 308 may operate in the hybrid mode.

More specifically, water (or another cooling fluid such as brine) that is circulated through the building 10 by the water conduits 16 described above, enters the refrigeration system 300 through the piping 302 and travels through the heat exchanger 324. As described in greater detail below, when the system is operating in either the free-cooling mode or the hybrid mode, the water is cooled by refrigerant in the heat exchanger 324. The water then travels through the piping 306. Valves 311 and 314 are two position valves coupled to the piping 306. When the valve 311 is in an open position and the valve 314 is in the closed position, water can flow from the piping 306 to the piping 318, bypassing the evaporator 316. Water in the piping 318 is returned to the building 10 via the water conduits 16 (FIG. 1). When the valve 311 is in the closed position, and the valve 314 is in the open position, water is prevented from flowing directly from the piping 306 to the piping 318. Water can flow from the piping 306 into the evaporator 316. In conditions in which the valve 314 is in the open position, water flows through the evaporator 316, where it is cooled, into the piping 318, where it is returned to the building 10 via the conduits 16. In some aspects, the valve 311 may be optional. In aspects that do not include the valve 311, water will always flow through the evaporator 316. Alternatively, the valve 311 and the valve 314 also can be replaced with a 3-way proportional valve.

When the refrigeration system 300 operates in the mechanical cooling mode, the direction of refrigerant circulation is represented by arrow A. Specifically, vapor refrigerant flows from the compressor 304 to the cooling coils 308 via a piping 328. The vapor refrigerant condenses into liquid or a mixture of liquid and vapor refrigerant in the cooling coils 308. The fans 310 coupled to the cooling coils 308 may facilitate heat transfer between the mixture of liquid and gas in the cooling coils 308 and the air. In some aspects, the fans 310 may be variable speed fans. In such aspects, the controller 326 may be configured to control the speed of the fans 310 based on a desired amount of heat transfer between the cooling coils 308 and the ambient air. The liquid refrigerant exiting the cooling coils 308 is collected via a second piping 332, and then travels through the expansion valve 312 to the evaporator 316. The liquid refrigerant evaporates in the evaporator 316, absorbing heat from the water from the building 10 traveling to and from the evaporator 316 via the piping 306, 318. The vapor refrigerant travels back to the compressor 304 along the piping 334, as shown by the arrow A. The pump 320 and the heat exchanger 324 are not used in the mechanical cooling mode. In some aspects, a check valve 336 may prevent fluid from entering the pump 320 during the mechanical cooling mode. In some aspects, a subcooler 340 may be positioned along the second piping 332 between the cooling coils 308 and the expansion valve 312 to subcool the refrigerant liquid in the second piping 332 or condense any vapor present in the second piping 332. In some aspects, a fan 344 may be coupled to the subcooler 340 to facilitate heat transfer between the refrigerant in subcooler 340 and the ambient air.

In some aspects, the evaporator 316 may include an evaporator heater 360 to reduce a likelihood of freezing conditions in the evaporator. In such aspects, the evaporator heater 360 may be energized during a standby period to reduce the likelihood of freezing conditions in the evaporator. In some aspects, a reservoir may be positioned upstream of the pump and configured to supply liquid refrigerant to the pump 320 when the pump 320 is turned on at the initiation of the free-cooling mode or the hybrid mode. In some aspects, the pump 320 may be lower than other components of the system 300, so that gravity helps feed liquid refrigerant to the pump 320, which may prevent the pump 320 from running dry. In some aspects, the reservoir may be oriented so that the reservoir is below the piping 332. In such aspects, the pump 320 may draw refrigerant from the bottom of the reservoir, which may prevent the pump 320 from taking in air/vapor.

When the refrigeration system 300 operates in the free-cooling mode, cool liquid refrigerant enters the second piping 332 from the cooling coils 308 as shown by the arrow B. This cool liquid refrigerant is pumped via the pump 320 into the heat exchanger 324, where the cool liquid refrigerant absorbs heat from the water from the building 10 entering the heat exchanger 324 via the piping 302. Liquid refrigerant or a mixture of liquid and vapor refrigerant exits the heat exchanger 324 into piping 348, and enters a three-way valve 352. The three-way valve 352 is configured to prevent refrigerant in the piping 328 from entering the heat exchanger 324. The three-way valve 352 is configured to allow liquid refrigerant to travel from the piping 348 to the piping 328 via the valve 352. The liquid refrigerant then travels from the piping 328 into the cooling coils 308. A check valve 356 may prevent liquid refrigerant from entering the compressor 304. The valve 352 may also allow liquid refrigerant to enter piping 328 proximate the outlet of the compressor 304. As described in greater detail below, this portion of the valve 352 may be opened during the hybrid mode to allow liquid refrigerant to enter the portion of the cooling coils 308 that are operating in the mechanical cooling mode via the piping 354. Arrow B shows the direction of circulation of refrigerant in the free-cooling mode. The compressor 304, subcooler 340, and evaporator 316 are not used in the free-cooling mode. In some aspects, the valve 314 may be in the closed position and the valve 311 may be in the open position in the free-cooling mode, allowing the cooled water to bypass the evaporator 316. In some aspects, the evaporator heater could be energized to reduce the likelihood of the evaporator 316 freezing when no or substantially no water flows through the evaporator 316 under low ambient temperature conditions.

As shown above, the cooling coils 308 are used during both mechanical cooling and free-cooling. The particular number of cooling coils 308 used for mechanical cooling or free-cooling can vary based on the commands sent from the controller 326 to the compressor 304 and/or the pump 320 during the hybrid mode. An example operation of the controller 326 apportioning use of the cooling coils 308 between the mechanical cooling and free-cooling operations is described below in more detail.

During the hybrid operating mode, both the mechanical cooling process and the free-cooling process are operational, sharing use of the cooling coils 308 as managed by the controller 326. During the hybrid mode, the controller 326 is configured to operate the compressor 304 and the pump 320 to direct the first portion of the refrigerant along the mechanical cooling loop shown by the arrows A using a first portion of the cooling coils 308 and the second portion of the refrigerant along the free-cooling loop shown by the arrows B using a second portion of the cooling coils 308. Although the number of the cooling coils 308 operated in the mechanical cooling loop and the free-cooling loop may vary, all of the coils 308 are operational during the hybrid mode. In some aspects, the piping 328 may be oriented such that the portion of the piping 328 proximate the end coupled to the heat exchanger 324 is lower than the end coupled to the compressor 304. This may prevent mixing of the liquid and vapor refrigerant streams when the system 300 is operating in the hybrid mode.

For example, the controller 326 may be configured to receive temperature information such as information indicative of an ambient temperature of the environment around the cooling system 300, a temperature of the incoming water from the building 10, a temperature of the refrigerant entering or near the heat exchanger 324, a temperature of the refrigerant leaving the cooling coils 308, and so forth from one or more temperature sensors in the environment, in the pipes near the incoming water from the building 10, near the inlet of the heat exchanger 324, and/or near an outlet of the cooling coils 308, and so forth, respectively. The controller 326 may be configured to determine, based on the received information, a first proportion of the refrigerant that should be operated in the mechanical cooling mode and a second portion of the refrigerant that should be operated in the free-cooling mode to provide a desired amount of cooling of the incoming water from the building 10. The controller 326 may be configured to determine a pumping rate at which the determined first portion of refrigerant operates according to the mechanical cooling mode and the determined second portion of refrigerant operates according to the free cooling mode. The pumping rate may be configured to apportion the flow of the refrigerant such that the first portion of the refrigerant flows through the mechanical cooling loop and the second portion of the refrigerant flows through the free-cooling loop. The controller 326 may be configured to operate the pump 320 at the determined pumping rate.

In some aspects, in response to determining that the refrigerant leaving the cooling coils 308 (or a temperature of the refrigerant near or entering the heat exchanger 324) is warmer than the water from building 10, the controller 326 may command the system 300 to exit the hybrid or free-cooling mode and operate in the mechanical cooling mode.

In some aspects, the controller 326 may be configured to receive information indicative of a temperature and/or a pressure near an inlet of the pump 320. The controller 326 may be configured to determine, based on the received information, that subcooled liquid refrigerant is entering the pump 320 and/or in the piping 332 near the pump 320. In some aspects, a water bypass valve may be positioned around the evaporator 316 and a heater may be coupled to the evaporator 316 to maintain a temperature of the evaporator 316 above the freezing point of chilled liquid flowing through evaporator.

In some aspects, the controller 326 may be configured to receive information indicative of a pressure drop across the pump 320 from a pump sensor and to receive information indicative of a pressure drop through the cooling coils 308 from one or more pressure sensors. In some aspects, a first pressure sensor may be positioned in the piping 332 or at an inlet of the pump 320, a second pressure sensor may be positioned at outlet of the pump 320, and a third pressure sensor may be positioned in the piping 328. In such aspects, the controller 326 may determine the head of the pump based on a difference between the pressure determined by the first pressure sensor and the pressure determined by the second pressure sensor. The controller 326 may be determine speed of the pump 320 based on the frequency of the pump 320. The controller 326 may then determine the volumetric flow rate (e.g., gallons per minute) of the refrigerant flowing through the pump 320. In some aspects, the controller 326 may determine the volumetric flow rate through the pump 320 based on a graph, a look-up table, etc. The controller 326 may then determine the free cooling capacity (Qc) based on the temperature and pressure of the refrigerant at or proximate the inlet of the heat exchanger 324 (e.g., determined by temperature and pressure sensors positioned at or proximate the inlet of the heat exchanger 324), the temperature and pressure of the refrigerant at or proximate the outlet of the heat exchanger 324 (e.g., determined by temperature and pressure sensors positioned at or proximate the outlet of the heat exchanger 324), and the volumetric flow rate of the refrigerant flowing through the pump 320. The controller 326 may then compare the determined Q_{C} to a target free cooling capacity Q_{T} for the current ambient environmental conditions of the system 300. In response to the comparison indicating that Q_{C}<(Q_{T}−ΔQ), the controller 326 may increase the frequency of the pump 320. In response to the comparison indicating that Q_{C}>(Q_{T}−ΔQ), the controller 326 may decrease the frequency of the pump 320. In response to the comparison indicating that (Q_{T}-ΔQ)<Q_{C}<(Q_{T}+ΔQ), the controller 326 may maintain the current frequency of the pump 320. In some aspects, the ΔQ value may be a configurable value that sets a dead band to prevent excessive changes in the pump frequency. This may prevent mixing of the liquid and vapor refrigerant streams traveling through the cooling coils 308. In some aspects, the controller 326 may command the three-way valve 352 to inject liquid refrigerant into the coils 308 operating according to the mechanical cooling loop (and therefore receiving gas refrigerant from the compressor 304) to help match the pressure drop across the first portion of the cooling coils 308 (e.g., the cooling coils 308 operating in the mechanical cooling loop) to the pressure drop across the second portion of the cooling coils 308 (e.g., the cooling coils 308 operating in the free-cooling loop).

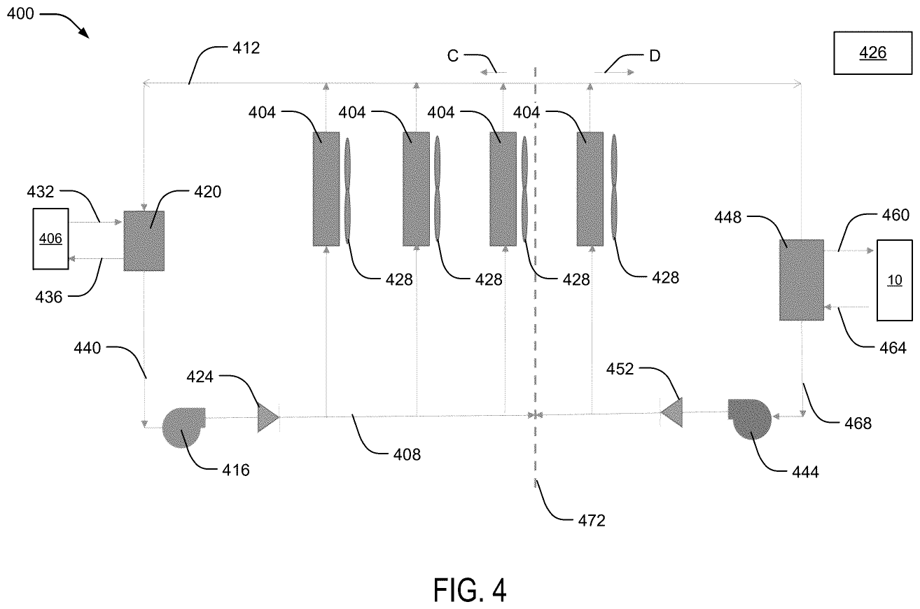

Referring to FIG. 4, another example refrigeration system 400 also includes a plurality of cooling coils 404 that are shared between a mechanical cooling loop and a free-cooling loop, and wherein the liquid refrigerant of the refrigeration system 400 is configured to cool a second refrigerant of a mechanical cooling system, which is shown schematically as block 406. The free-cooling loop is configured to cool water from conduits 16 of a building 10 (FIG. 1). The system 400 may operate in a first mode in which all of the cooling coils 404 are be used by the mechanical cooling loop, a second mode in which all of the cooling coils 404 are used by the free-cooling loop, and a third mode (e.g., a hybrid mode) in which the cooling coils 404 are shared between the mechanical cooling loop and the free-cooling loop, as described herein. All of the cooling coils 404 may be used in the third mode.

The cooling coils 404 are coupled between piping 408 and second piping 412. A first end of the piping 408 is coupled to a first or condenser pump 416 that is configured to receive warm liquid refrigerant from a condenser 420. In some aspects, the condenser pump 416 may be a variable speed pump. When the system is operating in the mechanical cooling mode or the hybrid mode, the flow of liquid refrigerant through the mechanical cooling loop is shown generally by the arrow C. In particular, the condenser pump 416 is configured to pump the liquid refrigerant through the piping 408 into the cooling coils 404. A check valve 424 may be positioned downstream of the condenser pump 416 to prevent backflow of the liquid refrigerant into the pump 416. The liquid refrigerant then flows to the cooling coils 404, where ambient air cools the liquid refrigerant. In some aspects, fans 428 may be coupled to the cooling coils 404. In some aspects, the fans 428 may be operated to increase heat transfer between the liquid refrigerant flowing through the cooling coils 404 and the ambient air. Cool liquid refrigerant leaving the cooling coils 404 travels through the second piping 412 to the condenser 420. The condenser 420 is configured to receive a flow of hot vapor of another refrigerant from a compressor of the mechanical cooling system 406 via the piping 432. The cool liquid refrigerant entering the condenser 420 via the second piping 412 cools the flow of hot vapor phase of the other refrigerant from the mechanical cooling system 406, for instance, cooling the other refrigerant until the other refrigerant condenses into a liquid. The liquid phase of the other refrigerant exits the condenser 420 via the piping 436, where it then travels to an expansion device of the mechanical cooling system 406. This heat exchange converts the cool liquid refrigerant entering the condenser 420 into a hot liquid refrigerant, which exits the condenser 420 and travels to the pump 416 via piping 440.

A second end of the piping 408 is coupled to a second or free-cooling pump 444 that is configured to receive warm liquid refrigerant from a heat exchanger 448. In some aspects, the free-cooling pump 444 may be a variable speed pump.

When the system is operating in the free-cooling mode or the hybrid mode, the flow of liquid refrigerant through the free-cooling loop is shown generally by the arrow D. In particular, the free-cooling pump 444 is configured to pump liquid refrigerant through the piping 408 into the cooling coils 404. A check valve 452 may be positioned downstream of the free-cooling pump 444 to prevent backflow of the liquid refrigerant into the free-cooling pump 444. The liquid refrigerant then flows to the cooling coils 404, where ambient air cools the liquid refrigerant. In some aspects, fans 428 may be coupled to the cooling coils 404. In some aspects, the fans 428 may be operated to increase heat transfer between the liquid refrigerant flowing through the cooling coils 404 and the ambient air. The fans 428 may be variable speed fans. The controller 426 (e.g., a processor) can control the speed of the fans 428 based on a desired amount of heat transfer with ambient air. Cool liquid refrigerant leaving the cooling coils 404 travels through the second piping 412 to the heat exchanger 448. The heat exchanger 448 is configured to receive a flow of warm water from the building 10 conduits 16 via piping 464. The cool liquid refrigerant entering the heat exchanger 448 via the second piping 412 cools the flow of water from the building 10. The cooled water exits the heat exchanger via the piping 460, where it then returns to the conduits 16 of the building 10. The warm liquid refrigerant exits the heat exchanger 448 and travels to the pump 444 via piping 468.

In some aspects, the cooling coils 404 may be microchannel coils with single refrigerant pass. In such aspects, the cooling coils 404 may be aluminum. In other aspects, the cooling coils 404 may be aluminum or copper plate-fin coils with copper tubes. The cooling coils 404 may be configured to accommodate both condensing vapor and liquid refrigerant without a large pressure drop. In some aspects, the heat exchanger 448 may be a brazed-plate heat exchanger.

During the hybrid operating mode, both the mechanical cooling process and the free-cooling process are operational. During the hybrid mode, the controller 426 is configured to operate the condenser pump 416 to direct the first portion of the refrigerant along the mechanical cooling loop shown by the arrows C using a first portion of the cooling coils 404 and operate the free-cooling pump 444 to direct the second portion of the refrigerant along the free-cooling loop shown by the arrows D using a second portion of the cooling coils 404. Although a number of the cooling coils 404 operated in the mechanical cooling loop and the free-cooling loop may vary, all of the coils 404 are operational during the hybrid mode. For example, in FIG. 4, the system 400 is operating in the hybrid mode. As schematically indicated by flow boundary line 472, in the aspect of FIG. 4, three cooling coils 404 are operated in the mechanical cooling loop and one cooling coil 404 is operated in the free-cooling loop. However, in other configurations, the usage of the cooling coils 404 may be different. For example, in some aspects, two cooling coils 404 may operate in the mechanical cooling loop and two cooling coils 404 may operate in the free-cooling loop. In another example, one cooling coil 404 may operate in the mechanical cooling loop and three cooling coils 404 may operate in the free-cooling loop. The portion of the liquid refrigerant operating in the mechanical cooling loop (e.g., the first portion) may be hotter than the portion of the liquid refrigerant operating in the free-cooling loop (e.g., the second portion). This temperature difference may prevent or reduce an amount of mixing between the first and second portions of liquid refrigerant.

For example, the same as or similar to the operation of controller 326 (FIG. 3) described above, the controller 426 may be configured to receive information indicative of an ambient temperature of the environment around the cooling system 300, a temperature of the incoming water from the building 10, and so forth. The controller 426 may be configured to determine, based on the received information, a first proportion of the refrigerant (or the cooling coils 404) that should be operated in the mechanical cooling mode and a second portion of the refrigerant (or cooling coils 404) that should be operated in the free-cooling mode to provide a desired amount of cooling to the incoming water from the building 10 and to the second refrigerant from the mechanical cooling system 406. The controller 426 may be configured to determine relative pumping rates (e.g., a first pumping rate for the condenser pump 416 and a second pumping rate for the free-cooling pump 444) for the condenser pump 416 and the free-cooling pump 444 configured to apportion the refrigerant as desired between the mechanical cooling loop and the free-cooling loop. The controller 426 may be configured to command the pumps 416, 444 to operate at the determined pumping rates.

In some aspects, the controller 426 may be configured to receive information indicative of a temperature of the refrigerant entering or near the heat exchanger 448, a temperature of the refrigerant leaving the cooling coils 404, and so forth from one or more temperature sensors in the pipes near the inlet of the heat exchanger 448, and/or near an outlet of the cooling coils 404, and so forth, respectively. In response to determining that the refrigerant leaving the cooling coils 404 (or a temperature of the refrigerant near or entering the heat exchanger 448) is warmer than the building water 10, the controller 426 may command the system 400 to exit the hybrid or free-cooling mode and operate in the mechanical cooling mode.

In some aspects, the controller 426 may be configured to receive information indicative of a temperature of the liquid refrigerant entering each cooling coil 404 from a temperature sensor 476 proximate an inlet of each of the cooling coils 404. In such aspects, the controller 426 may be configured to change the pumping rates of the condenser pump 416 and the free-cooling pump 444 to increase a temperature difference between the cooling coils 404 on either side of the flow boundary between the cooling coils 404 operating in the mechanical cooling loop and the cooling coils 404 operating the free-cooling loop (e.g., the cooling coils 404 on either side of the line 472). For example, the controller 426 may compare the temperature of the liquid refrigerant entering the cooling coils operating in the mechanical cooling loop and the temperature of the liquid refrigerant entering the cooling coils operating in the free cooling loop. The controller 426 may determine a difference between the temperature of the liquid refrigerant entering the cooling coils operating in the mechanical cooling loop and the temperature of the liquid refrigerant entering the cooling coils operating in the free cooling loop and confirm the temperature difference to a temperature threshold. In response to determining that the temperature difference is lower than the temperature threshold, the controller 426 may change the pumping rates of the condenser pump 416 and/or the free cooling pump 444 to increase the temperature difference. In response to determining that the temperature difference is greater than or equal to the temperature threshold, the controller 426 may maintain the current the pumping rates of the condenser pump 416 and/or the free cooling pump 444.

The controller 426 may also be configured to control relative rates of the pumps 416, 444 based on the number of cooling coils 404 used in the mechanical cooling loop and the free-cooling loop, respectively. For example, in the illustrated aspect, the mechanical cooling loop is using three cooling coils 404 and the free-cooling loop is using one cooling coil 404. Under such conditions, the controller 426 may be configured to command the condenser pump 416 to operate at a rate substantially three times faster than the free-cooling pump 444. In another example, the mechanical cooling may use two cooling coils 404 and the free-cooling loop may use two cooling coils 404. Under such conditions, the controller 426 may be configured to command the condenser pump 416 and the free-cooling pump 444 to operate at substantially the same rate. In another example, the mechanical cooling may use one cooling coil 404 and the free-cooling loop may use three cooling coils 404. Under such conditions, the controller 426 may be configured to command the free-cooling pump 444 to operate at a rate that is substantially three times faster than a rate of the condenser pump 416.

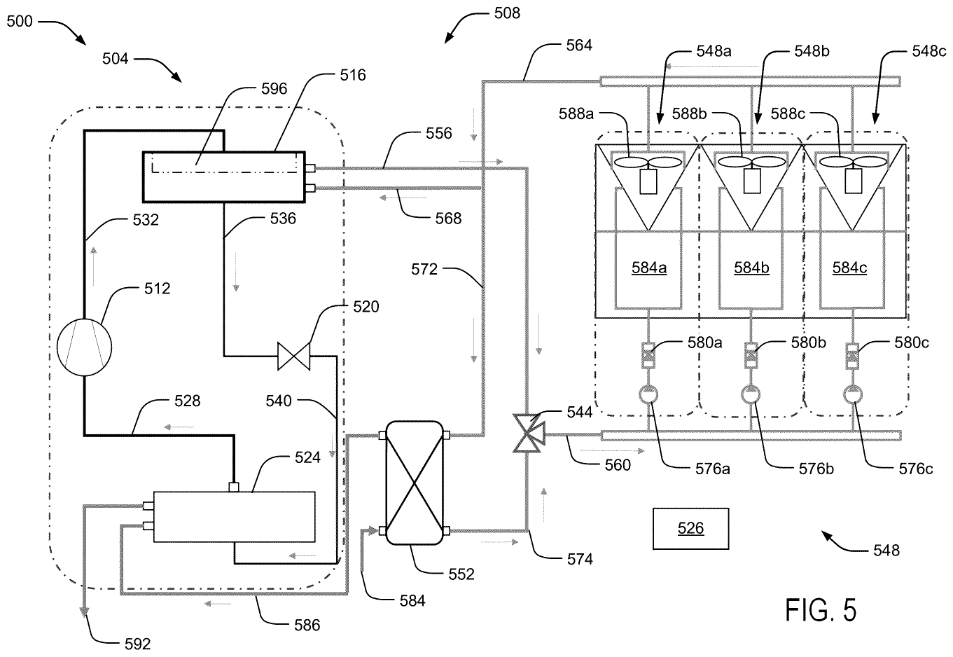

Referring to FIG. 5, an example refrigeration system 500 includes a mechanical cooling loop 504 and a free-cooling loop 508, wherein the mechanical cooling loop 504 includes a first refrigerant and the free-cooling loop 508 includes a second refrigerant different from the first refrigerant. In some aspects, the first refrigerant may be R1234ze, R134a, R410a, and other similar refrigerants suitable for reducing temperature. In some aspects, the second refrigerant may be glycol liquid, fresh water, or another substance suitable for reducing temperature. In environmental conditions in which the ambient temperature does not drop below the freezing point of water, the second refrigerant may be water. The second refrigerant is configured to cool the first refrigerant. As is described in greater detail below, the system 500 may operate in a first mode in which the mechanical cooling loop 504 is configured to cool water from conduits 16 of the building 10, a second mode in which the free-cooling loop 508 is configured to cool water from the conduits 16 of the building 10, and a third mode in which both the mechanical cooling loop 504 and the free-cooling loop 508 are configured to cool water from the conduits 16 of the building 10.

Mechanical cooling loop 504 includes a compressor 512, a condenser 516, an expansion device 520, and an evaporator 524. The first refrigerant enters the compressor 512 (e.g., from an outlet of the evaporator 524) through piping 528. The first refrigerant then travels from the compressor 512 to the condenser 516 via piping 532. In the condenser 516, the first refrigerant is cooled by the second refrigerant such that the first refrigerant condenses into a liquid or a mixture of liquid or vapor. In some aspects, the condenser 516 may be a shell-and-tube condenser. The first refrigerant then travels from the condenser 516 to the expansion device 520 via piping 536. The first refrigerant travels from the expansion device 520 to the evaporator 524 via piping 540. The liquid first refrigerant evaporates in the evaporator 524, absorbing heat from the water from the building as the water travels through the evaporator 524. The first refrigerant then travels to the compressor 512 via the piping 528.

The free-cooling loop 508 includes the condenser 516, a proportional valve 544, a plurality of cooling towers 548, and a heat exchanger 552. In some aspects, the cooling towers are dry cooling towers 548. As discussed above, the second refrigerant cools the first refrigerant in the condenser 516. Warm second refrigerant exits the condenser 516 via piping 556. The warm second refrigerant enters the proportional valve 544 and travels from the proportional valve 544 to the plurality of cooling towers 548 via the piping 560. The second refrigerant travels through the plurality of cooling towers 548, where it is cooled by ambient air. Cool second refrigerant leaving the cooling towers 548 enters the piping 564. A first portion of the cool second refrigerant enters the condenser 516 via piping 568. A second portion of the cool second refrigerant travels to the heat exchanger 552 via the piping 572. The cool second refrigerant absorbs heat from the water from the building as the water from the building travels through the heat exchanger 552. Warm second refrigerant exits the heat exchanger 552 and travels to the valve 544, and then travels to the cooling towers 548 via the piping 560. The position of the valve 544 is configured to determine the proportion of refrigerant entering the piping 560 and 574. When the system 500 is operating in the mechanical cooling mode, the valve 544 is configured to direct the second refrigerant to the condenser 516 (e.g., substantially all of the second refrigerant is in the first portion). When the system 500 is operating in the free-cooling mode, the valve 544 is configured to direct the second refrigerant to the heat exchanger 552 (e.g., substantially all of the refrigerant is in the second portion). When the system 500 is operating in the hybrid mode, the position of the valve 544 is configured to apportion the refrigerant exiting the piping 564 into the first and second portions. Warm second refrigerant exiting the heat exchanger 552 enters the piping 574, and travels through the valve 544 and through the piping 560 and into the cooling towers 548.

In the illustrated aspect, the plurality of cooling towers 548 includes three cooling towers 548a, 548b, 548c arranged in parallel. In other aspects, the plurality of cooling towers 548 may include more or fewer cooling towers. The cooling towers 548a, 548b, 548c are substantially similar, so only the cooling tower 548a is described in detail herein. Like numbers are used to indicate like parts between the cooling towers 548a, 548b, 548c. The cooling tower 548a includes a pump 576a, a check valve 580a, a plurality of cooling coils 584a, and a fan 588a. The pump 576a is configured to pump the second refrigerant into the cooling coil 584a. The fan 588a is configured to increase heat transfer with ambient air. The check valve 580a is movable between a first or open position and a second or closed position. In some aspects, the controller 526 (e.g., a processor) may be configured to turn on or off one or more of the pumps 576a-c based on the requirements of the system 500. For example, the controller 526 may be configured to receive information indicative of an ambient temperature, a temperature of the second refrigerant leaving the cooling towers 548a, 548b, 548c, a temperature of the building water, and so forth from one or more temperature sensors. The controller 526 may be able to determine, based on the received temperature information, a number of the cooling towers 548a, 548b, 548c to operate, a pump speed for the pumps 576a, 576b, 576c, a fan speed for the fans 588a, 588b, 588c, and so forth. For example, for relatively cool ambient temperatures (e.g., ambient temperatures lower than a predefined temperature threshold), the second refrigerant may be able to be cooled without using all of the cooling towers 548. Under such conditions, the controller 526 may command one or more of the pumps 576 to turn off. This may occur in conditions in which the ambient temperature is much cooler than a target temperature of the second refrigerant, the controller 526 may command one or more of the pumps 576 to turn off. This may result in energy savings because the pumps 576 and fan 588 for the unused cooling towers 548 are turned off. For example, for relatively warm ambient temperatures (e.g., ambient temperatures above a predefined temperature threshold), the controller 526 may command one or more of the pumps 576 to turn on, increase a speed of the fans 588a, 588b, 588c, and so forth. This may occur in conditions in which the ambient temperature is close to the target temperature of the second refrigerant, the controller 526 may command one or more of the pumps 567 to turn on.

The building water is configured to enter the system 500 via piping 584. The water travels through the piping 584 to the heat exchanger 552. In aspects in which the free-cooling loop 508 is operational (e.g., when the system 500 is operating in the second mode or the third mode), the water is cooled by the second refrigerant in the heat exchanger 552. The water travels from the heat exchanger 552 to the evaporator 524 via piping 586. In aspects in which the mechanical cooling loop 504 is operational (e.g., when the system 500 is operating in the first mode or the third mode), the evaporation of the first refrigerant absorbs heat from the water in the evaporator 524. The cooled water returns to the building conduits 16 via the piping 592.

When the system 500 is operating in the hybrid mode, both the mechanical cooling loop 504 and the free-cooling loop 508 operate. During the hybrid mode, the building water is cooled by both the heat exchanger 552 and the evaporator 524.

In some aspects, the compressor 512 may be an oil-injected screw compressor. In such aspects, the condenser 516 may include an integral oil separator 596. In such aspects, a difference between a discharge pressure at an inlet of the condenser 516 and a suction pressure at an inlet of the compressor 512 may drive the oil to the compressor 512 to lubricate the compressor 512.

In other aspects, the condenser 516 may be a brazed-plate condenser. In such aspects, a separate oil separator may be used to supply oil to the compressor 512. In some aspects, the compressor 512 may be a centrifugal compressor, a scroll compressor, or another type of compressor with relatively low oil circulation. In such aspects, the oil separator may not be used.

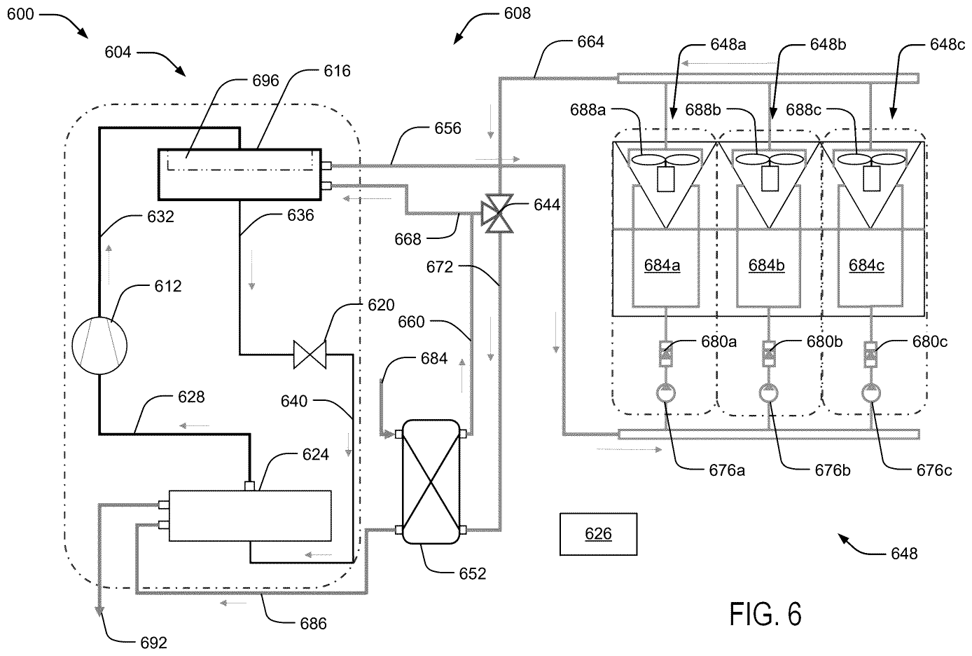

Referring to FIG. 6, an example refrigeration system 600 includes a mechanical cooling loop 604 and a free-cooling loop 608 similar to refrigeration system 500, but a valve, such as the valve 644, is positioned between cooling towers 648 and a condenser 616 including an integral oil separator 696, such that a portion of the cool refrigerant leaving the cooling towers 648 can travel through a heat exchanger 652 before the condenser 616 The liquid refrigerant absorbs heat from the building water in the heat exchanger 652. The warmer liquid refrigerant flowing from the heat exchanger 652 into the condenser 616 increases the temperature of the liquid second refrigerant entering the condenser 616. This may increase the discharge pressure of liquid refrigerant leaving the condenser 616, which in turn may a force of the discharge pressure on the oil within the oil separator 969, thereby urging lubricant to the compressor 612. The refrigeration system 600 is substantially similar to the system 500 and will only be described in detail herein as it differs from the system 500. Like parts between the system 500 and the system 600 are shown using like numbering.

The free-cooling loop 608 includes a condenser 616, a proportional valve 644, a plurality of cooling towers 648, and a heat exchanger 652. As discussed above, the second refrigerant cools the first refrigerant in the condenser 616. Warm second refrigerant exits the condenser 616 via piping 656 and travels to the plurality of cooling towers 648. The second refrigerant travels through the plurality of cooling towers 648, where it is cooled by ambient air. Cool second refrigerant leaving the cooling towers 648 enters the piping 664 and travels to the valve 644. The valve 644 is configured to direct a first portion of the cool second refrigerant to enter the condenser 616 via piping 668. The valve 644 is configured to direct a second portion of the cool second refrigerant to the heat exchanger 652 via the piping 672. The cool second refrigerant absorbs heat from the water from the building as the water from the building and the cool second refrigerant travel through the heat exchanger 652. Warm second refrigerant exits the heat exchanger 652 and travels to the condenser 616 via the piping 660. The position of the valve 644 is configured to determine the proportion of refrigerant entering the piping 668 and 672. When the system 600 is operating in the mechanical cooling mode, the valve 644 is configured to direct the second refrigerant to the condenser 616 (e.g., substantially all of the second refrigerant is in the first portion). When the system 600 is operating in the free-cooling mode, the valve 644 is configured to direct the second refrigerant to the heat exchanger 652 (e.g., substantially all of the refrigerant is in the second portion). When the system 600 is operating in the hybrid mode, the position of the valve 644 is configured to apportion the refrigerant exiting the piping 664 into the first and second portions.

When the system 600 is operating in the hybrid mode, both the mechanical cooling loop 604 and the free-cooling loop 608 operate. During the hybrid mode, the building water is cooled by both the heat exchanger 652 and the evaporator 624.

In some aspects, the compressor 612 may be an oil-injected screw compressor. In such aspects, the condenser 616 may include an integral oil separator 696. In such aspects, a difference between a discharge pressure at an inlet of the condenser 616 and a suction pressure at an inlet of the compressor 612 may drive the oil to the compressor 612 to lubricate the compressor 612. In some aspects, the controller 626 (e.g., a processor) may be configured to receive information indicative of the suction pressure and/or the discharge pressure. The controller 626 may be configured to compare the suction pressure, the discharge pressure, and/or difference between the suction pressure and the discharge threshold to a target pressure threshold. In response to determining that the suction pressure, the discharge pressure and/or the difference between the suction pressure and the discharge pressure is below the target pressure threshold, the controller 626 may be configured to reposition the valve 644 to increase an amount of cold liquid refrigerant entering the heat exchanger 652, where the cold liquid refrigerant absorbs heat from the building water. The liquid refrigerant then flows from the heat exchanger 652 to the condenser 616, increasing the temperature of the liquid second refrigerant entering the condenser 616. Increasing the temperature of the second refrigerant entering the condenser 616 will increase the discharge pressure of liquid refrigerant leaving the condenser 616, which increases a force of the discharge pressure on the oil within the oil separator 969, thereby urging lubricant to the compressor 612.

In some aspects, when the system 600 is operating in the free-cooling mode, the controller may operate the pump(s) 676a, 676b, 676c at a high speed to maximize an amount of free-cooling.

In other aspects, the condenser 616 may be a brazed-plate condenser. In such aspects, a separate oil separator may be used to supply oil to the compressor 612. In some aspects, the compressor 612 may be a centrifugal compressor, a scroll compressor, or another type of compressor with relatively low oil circulation. In such aspects, the oil separator may not be used.

In some aspects, during the free-cooling modes, the controllers 326, 426, 526, 626 may be configured to control a speed of the free-cooling pumps 320, 444, 576a-c, 676a-c to prevent freezing conditions in the heat exchangers 324, 448, 552, 652. In some aspects, the systems 300, 400, 500, 600 may adjust the speed of the fan 668 as second refrigerant flows through a cooling coil/cooling tower to prevent freezing conditions in the heat exchangers 324, 448, 552, 652. In some aspects, the fan speed can be determined by the refrigerant temperature in piping 664. For example, the fan peed may be controlled such that the temperature in the piping 664 is equal to or above freezing point of the water from building 10 or slightly below the freezing point of the water from the building 10.

While the systems 300, 400, 500, 600 show a single refrigerant circuit in the examples illustrated herein, it is contemplated that in some aspects the systems 300, 400, 500, 600 can include multiple refrigerant circuits. In compact multi-circuit systems, stacked cooling coils may be used so that the ambient air flows through the cooling coils for the refrigerant circuits in a series configuration. In some aspects, in the evaporators of multiple refrigerant circuits, water from the building 10 may flow in series through the evaporator for each refrigerant circuit.

Additionally, the systems 300, 400, 500, 600 may provide one or more of the following advantages relative to existing solutions: lower cost, smaller space requirement, simplified piping, higher performance, improved freeze protection, ability to use aluminum without corrosion issues, simple controls, and/or the ability to select coils for free-cooling or condenser heat rejection.

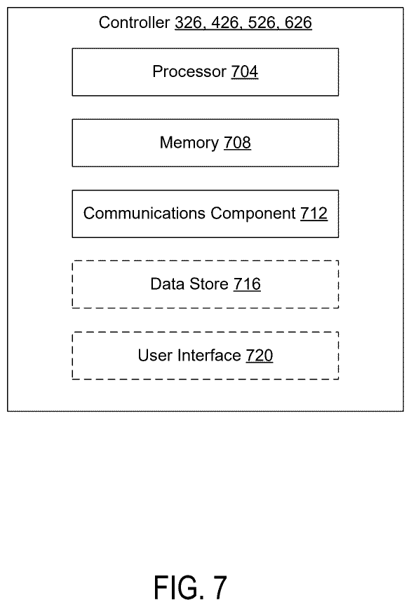

Referring to FIG. 7, in one aspect, the controllers 326, 426, 526, 626 may further include one or more additional components that may operate in conjunction with systems 300, 400, 500, 600. For example, each of the controllers 326, 426, 526, 626 may include a processor 704 for carrying out processing functions associated with one or more of components and functions described herein. Processor 704 can include a single or multiple set of processors or multi-core processors. Moreover, processor 704 can be implemented as an integrated processing system and/or a distributed processing system. In an aspect, for example, the controllers 326, 426, 526, 626 may be implemented as one or more a specially-programmed or configured processor modules of processor 704, or processor 704 may execute one or more computer-executable codes defining the controllers 326, 426, 526, 626 (e.g., the mechanical cooling mode, the free cooling mode, the hybrid mode), or some combination thereof.

The controllers 326, 426, 526, 626 may further include a memory 708, such as for storing data used herein and/or local versions of applications being executed by processor 704. Memory 708 can include any type of computer-readable medium usable by a computer or processor 704, such as random access memory (RAM), read only memory (ROM), tapes, magnetic discs, optical discs, volatile memory, non-volatile memory, and any combination thereof. In an aspect, for example, memory 708 may be a computer-readable storage medium that stores one or more computer-executable codes defining the controllers 326, 426, 526, 626 or data associated therewith, when the controllers 326, 426, 526, 626 are operating processor 704 to execute operations of the systems 300, 400, 500, 600 (e.g., operating components of the systems 300, 400, 500, 600 in the mechanical cooling mode, the free cooling mode, the hybrid mode or some combination thereof).

Also, the controllers 326, 426, 526, 626 may further include a communications component 712 that includes one or more buses that enable communication internally among components of the controllers 326, 426, 526, 626, and that includes one or more interfaces that enable communication with external devices. As such, communications component 712 is configured to establish and maintain communications with one or more entities utilizing hardware, software, and services as described herein. In an aspect, for example with respect to external communications, communications component 712 may further include transmit chain components (e.g., protocol layer entities, processor(s), modulator(s), antenna) and receive chain components (e.g., protocol layer entities, processor(s), demodulator(s), antenna) associated with one or more transmitters and receivers, respectively, or one or more transceivers, operable for interfacing with external devices. In an aspect, for example, communications component 712 may operate in cooperation with the components of the systems 300, 400, 500, 600 described herein to exchange and/or generate the communications and/or signaling described herein.

Optionally, in an aspect, the controllers 326, 426, 526, 626 may further include a data store 716, which can be any suitable combination of hardware and/or software, that provides for mass storage of information, databases, and programs employed in connection with aspects described herein. For example, the data store could store temperature and pressure tables of thermodynamic properties for the refrigerants used in the systems 300, 400, 500, 600. For example, data store 716 may be a computer-readable storage medium, such as a data repository, for computer-executable code and/or applications not currently being executed by processor 704.

In another optional implementation, the controllers 326, 426, 526, 626 may additionally include a user interface component 720 operable to receive inputs from a user of the systems 300, 400, 500, 600, and further operable to generate outputs for presentation to the user. User interface component 720 may include but is not limited to one or more input devices, including but not limited to a keyboard, a number pad, a mouse, a touch-sensitive display, a navigation key, a function key, a microphone, a voice recognition component, a mechanism capable of receiving an input from a user, or any combination thereof. Further, user interface component 720 may include but is not limited to one or more output devices, including but not limited to a display, a speaker, a haptic feedback mechanism, a printer, a mechanism capable of presenting an output to a user, or any combination thereof. In an aspect, for example, user interface component 720 may operate in cooperation with the controllers 326, 426, 526, 626 to exchange and/or generate the communications and/or signaling described herein.

The present disclosure may include aspects according to one or more of the following clauses.

Clause 1. A heating, ventilation, air conditioning, and refrigeration system, comprising: two or more cooling coils configured to receive a flow of a refrigerant; a mechanical cooling loop in fluid communication with the two or more cooling coils; a free-cooling loop in fluid communication with the two or more cooling coils; a pump in fluid communication with the two or more cooling coils; and a controller configured to: operate a speed of the pump to apportion the flow of the refrigerant between the two or more cooling coils such that a first portion of the refrigerant flowing through at least one of the two or more cooling coils is flowing along the mechanical cooling loop and a second portion of the refrigerant flowing through at least one of the two or more cooling coils is flowing along the free-cooling loop; wherein the mechanical cooling loop and the free-cooling loop are configured to operate simultaneously.

Clause 2. The heating, ventilation, air conditioning, and refrigeration system of clause 1, wherein the controller is configured to control the speed of the pump so that an actual free cooling capacity is substantially the same as a target free cooling capacity under ambient environmental conditions.

Clause 3. The heating, ventilation, air conditioning, and refrigeration system of clause 1 or clause 2, further comprising: a compressor in fluid communication with the two or more cooling coils and configured to circulate at least a first portion of the flow of the refrigerant through the mechanical cooling loop of the heating, ventilation, air conditioning, and refrigeration system; an evaporator configured to receive at least the first portion of the flow of the refrigerant from the two or more cooling coils, and configured to place the first portion of the flow of the refrigerant in a first heat exchange relationship with a fluid to be cooled by the mechanical cooling loop; a pump in fluid communication with the two or more cooling coils and configured to circulate at least a second portion of the flow of the refrigerant through the free-cooling loop of the heating, ventilation, air conditioning, and refrigeration system; and a heat exchanger in fluid communication with the pump and configured to place the second portion of the flow of refrigerant in a second heat exchange relationship with the fluid to be cooled by the free-cooling loop.

Clause 4. The heating, ventilation, air conditioning, and refrigeration system of clause 3, wherein the controller is configured to stop operation of the free-cooling loop in response to determining that a temperature of the refrigerant leaving the heat exchanger is warmer than a temperature of the fluid to be cooled.

Clause 5. The heating, ventilation, air conditioning, and refrigeration system of clause 3, wherein the controller is configured to command a valve positioned proximate an exit of the heat exchanger to move to a configuration in which refrigerant exiting the heat exchanger is injected into the first portion of the flow of the refrigerant through the mechanical cooling loop.

Clause 6. The heating, ventilation, air conditioning, and refrigeration system of clause 3, wherein the controller is configured to control the pump to prevent freezing conditions in the heat exchanger during operation of the free-cooling loop.

Clause 7. The heating, ventilation, air conditioning, and refrigeration system of any preceding clause, wherein the pump is a first pump and further comprising a second pump, and wherein the controller is configured to control the speed of the first and second pumps to apportion the flow of the refrigerant.

Clause 8. The heating, ventilation, air conditioning, and refrigeration system of clause 7, wherein the first pump is configured to direct refrigerant to the mechanical cooling loop and the second pump is configured to direct refrigerant to the free-cooling loop.

Clause 9. The heating, ventilation, air conditioning, and refrigeration system of clause 7, wherein the controller is configured to control the speed of the first and second pumps such that a difference between a temperature of the first portion of the refrigerant traveling through the cooling coils and a temperature of the second portion of the refrigerant traveling through the cooling coils is at least a predefined threshold.

Clause 10. The heating, ventilation, air conditioning, and refrigeration system of any preceding clause, wherein a number of the two or more cooling coils used for mechanical or free cooling can vary based on the speed of the pump.

Clause 11. The heating, ventilation, air conditioning, and refrigeration system of any preceding clause, wherein: the first portion of the refrigerant is configured to cool another refrigerant, the second portion of the refrigerant is configured to cool a flow of water from a building, and the controller is configured to apportion the flow of the refrigerant between the two or more cooling coils such that the first portion of the refrigerant provides a desired amount of cooling to the other refrigerant and the second portion of the refrigerant provides a desired amount of cooling to the flow of water from the building.

Clause 12. A heating, ventilation, air conditioning, and refrigeration system, comprising: a condenser, a heat exchanger, a plurality of cooling towers, each of the plurality of cooling towers including a valve allowing access to the cooling tower and a pump configured to pump refrigerant through the cooling tower; and a controller configured to: receive information indicative of one or more of an ambient temperature, a temperature of refrigerant leaving the plurality of cooling towers, a temperature of building water to be cooled by the heat exchangers, or combinations thereof from a temperature sensor; and turn on or off one or more of the pumps to allow or prevent access to one or more of the plurality of cooling towers based on the received temperature information.

Clause 13. The heating, ventilation, air conditioning, and refrigeration system of clause 12, wherein the controller is configured to turn one or more of the pumps off in response to determining that the ambient temperature is below a predefined threshold.

Clause 14. The heating, ventilation, air conditioning, and refrigeration system of clause 12 or 13, wherein the controller is configured to turn one or more of the pumps on in response to determining that the ambient temperature is above a predefined threshold.

Clause 15. The heating, ventilation, air conditioning, and refrigeration system of any of clause 12-14, wherein the refrigerant is a second refrigerant, and the heating, ventilation, air conditioning, and refrigeration system includes: a mechanical cooling loop including a compressor, the condenser, an expansion device, and an evaporator, the mechanical cooling loop configured to cool a first refrigerant; a free cooling loop including the condenser, the heat exchanger, and the plurality of cooling towers, the free cooling loop configured to cool the second refrigerant; and wherein the heating, ventilation, air conditioning, and refrigeration system is operable in a hybrid mode in which both the mechanical cooling loop and the free cooling loop are operational.

Clause 16. The heating, ventilation, air conditioning, and refrigeration system of clause 15, wherein during the hybrid mode, the building water is cooled by both the evaporator and the heat exchanger.

Clause 17. The heating, ventilation, air conditioning, and refrigeration system of clause 15, wherein the second refrigerant exiting the heat exchanger is cooled by the cooling towers during the hybrid mode.

Clause 18. The heating, ventilation, air conditioning, and refrigeration system of clause 15, wherein the controller is configured to control the pumps to prevent freezing conditions in the heat exchanger when the free cooling loop is operational.

Clause 19. The heating, ventilation, air conditioning, and refrigeration system of clause 15, wherein the condenser includes an integral oil separator including a lubricant, and wherein the controller is configured to: receive information indicative of a discharge pressure at an inlet of the condenser; receive information indicative of a suction pressure at an inlet of the compressor; and in response to determining that a difference between the suction pressure and the discharge pressure is below a predefined threshold, increase an amount of cold liquid refrigerant entering the heat exchanger, thereby increasing an amount of lubricant dispensed from the integral oil separator.

Clause 20. The heating, ventilation, air conditioning, and refrigeration system of any of clause 12-19, wherein the condenser includes an integral oil separator including a lubricant, and wherein a portion of refrigerant leaving the cooling towers travels to a heat exchanger before travelling to the condenser and is warmed before traveling to the condenser, and wherein the warmed portion of the refrigerant is configured to urge the lubricant to a compressor.

What is claimed is:

1. A heating, ventilation, air conditioning, and refrigeration system, comprising:
two or more cooling coils configured to receive a flow of a refrigerant;
a mechanical cooling loop in fluid communication with the two or more cooling coils;
a free-cooling loop in fluid communication with the two or more cooling coils;
a pump in fluid communication with the two or more cooling coils; and
a controller configured to:
operate a speed of the pump to apportion the flow of the refrigerant between the two or more cooling coils such that a first portion of the refrigerant flowing through at least one of the two or more cooling coils is flowing along the mechanical cooling loop and a second portion of the refrigerant flowing through at least one of the two or more cooling coils is flowing along the free-cooling loop;
wherein the mechanical cooling loop and the free-cooling loop are configured to operate simultaneously.

2. The heating, ventilation, air conditioning, and refrigeration system of claim 1, wherein the controller is configured to control the speed of the pump so that an actual free cooling capacity is substantially the same as a target free cooling capacity under ambient environmental conditions.

3. The heating, ventilation, air conditioning, and refrigeration system of claim 1, further comprising:
a compressor in fluid communication with the two or more cooling coils and configured to circulate at least a first portion of the flow of the refrigerant through the mechanical cooling loop of the heating, ventilation, air conditioning, and refrigeration system;
an evaporator configured to receive at least the first portion of the flow of the refrigerant from the two or more cooling coils, and configured to place the first portion of the flow of the refrigerant in a first heat exchange relationship with a fluid to be cooled by the mechanical cooling loop;
a pump in fluid communication with the two or more cooling coils and configured to circulate at least a second portion of the flow of the refrigerant through the free-cooling loop of the heating, ventilation, air conditioning, and refrigeration system; and
a heat exchanger in fluid communication with the pump and configured to place the second portion of the flow of refrigerant in a second heat exchange relationship with the fluid to be cooled by the free-cooling loop.

4. The heating, ventilation, air conditioning, and refrigeration system of claim 3, wherein the controller is configured to stop operation of the free-cooling loop in response to determining that a temperature of the refrigerant leaving the heat exchanger is warmer than a temperature of the fluid to be cooled.

5. The heating, ventilation, air conditioning, and refrigeration system of claim 3, wherein the controller is configured to command a valve positioned proximate an exit of the heat exchanger to move to a configuration in which refrigerant exiting the heat exchanger is injected into the first portion of the flow of the refrigerant through the mechanical cooling loop.

6. The heating, ventilation, air conditioning, and refrigeration system of claim 3, wherein the controller is configured to control the pump to prevent freezing conditions in the heat exchanger during operation of the free-cooling loop.

7. The heating, ventilation, air conditioning, and refrigeration system of claim 1, wherein the pump is a first pump and further comprising a second pump, and wherein the controller is configured to control the speed of the first and second pumps to apportion the flow of the refrigerant.

8. The heating, ventilation, air conditioning, and refrigeration system of claim 7, wherein the first pump is configured to direct refrigerant to the mechanical cooling loop and the second pump is configured to direct refrigerant to the free-cooling loop.

9. The heating, ventilation, air conditioning, and refrigeration system of claim 7, wherein the controller is configured to control the speed of the first and second pumps such that a difference between a temperature of the first portion of the refrigerant traveling through the cooling coils and a temperature of the second portion of the refrigerant traveling through the cooling coils is at least a predefined threshold.

10. The heating, ventilation, air conditioning, and refrigeration system of claim 1, wherein a number of the two or more cooling coils used for mechanical or free cooling can vary based on the speed of the pump.

11. The heating, ventilation, air conditioning, and refrigeration system of claim 1, wherein:
the first portion of the refrigerant is configured to cool another refrigerant,
the second portion of the refrigerant is configured to cool a flow of water from a building, and
the controller is configured to apportion the flow of the first refrigerant between the two or more cooling coils such that the first portion of the refrigerant provides a desired amount of cooling to the other refrigerant and the second portion of the refrigerant provides a desired amount of cooling to the flow of water from the building.

12. A heating, ventilation, air conditioning, and refrigeration system, comprising:
a condenser,
a heat exchanger,
a plurality of cooling towers, each of the plurality of cooling towers including a valve allowing access to the cooling tower and a pump configured to pump refrigerant through the cooling tower; and
a controller configured to:
receive information indicative of one or more of an ambient temperature, a temperature of refrigerant leaving the plurality of cooling towers, a temperature of building water to be cooled by the heat exchangers, or combinations thereof from a temperature sensor; and
turn on or off one or more of the pumps to allow or prevent access to one or more of the plurality of cooling towers based on the received temperature information.

13. The heating, ventilation, air conditioning, and refrigeration system of claim 12, wherein the controller is configured to turn one or more of the pumps off in response to determining that the ambient temperature is below a predefined threshold.

14. The heating, ventilation, air conditioning, and refrigeration system of claim 12, wherein the controller is configured to turn one or more of the pumps on in response to determining that the ambient temperature is above a predefined threshold.

15. The heating, ventilation, air conditioning, and refrigeration system of claim 12, wherein the refrigerant is a second refrigerant, and the heating, ventilation, air conditioning, and refrigeration system includes:
a mechanical cooling loop including a compressor, the condenser, an expansion device, and an evaporator, the mechanical cooling loop configured to cool a first refrigerant;
a free cooling loop including the condenser, the heat exchanger, and the plurality of cooling towers, the free cooling loop configured to cool the second refrigerant; and
wherein the heating, ventilation, air conditioning, and refrigeration system is operable in a hybrid mode in which both the mechanical cooling loop and the free cooling loop are operational.

16. The heating, ventilation, air conditioning, and refrigeration system of claim 15, wherein during the hybrid mode, the building water is cooled by both the evaporator and the heat exchanger.

17. The heating, ventilation, air conditioning, and refrigeration system of claim 15, wherein the second refrigerant exiting the heat exchanger is cooled by the cooling towers during the hybrid mode.

18. The heating, ventilation, air conditioning, and refrigeration system of claim 15, wherein the controller is configured to control the pumps to prevent freezing conditions in the heat exchanger when the free cooling loop is operational.

19. The heating, ventilation, air conditioning, and refrigeration system of claim 15, wherein the condenser includes an integral oil separator including a lubricant, and wherein the controller is configured to:
receive information indicative of a discharge pressure at an inlet of the condenser;
receive information indicative of a suction pressure at an inlet of the compressor; and
in response to determining that a difference between the suction pressure and the discharge pressure is below a predefined threshold, increase an amount of cold liquid refrigerant entering the heat exchanger, thereby increasing an amount of lubricant dispensed from the integral oil separator.

20. The heating, ventilation, air conditioning, and refrigeration system of claim 12, wherein the condenser includes an integral oil separator including a lubricant, and wherein a portion of refrigerant leaving the cooling towers travels to a heat exchanger before travelling to the condenser and is warmed before traveling to the condenser, and wherein the warmed portion of the refrigerant is configured to urge the lubricant to a compressor.
